(19) United States
(12) Patent Application Publication
(10) Pub. No.: US 2026/0149796 A1
(43) Pub. Date: May 28, 2026

(54) IMAGE PROCESSING APPARATUS, IMAGE PROCESSING METHOD, AND NON-TRANSITORY COMPUTER READABLE STORAGE MEDIUM

(71) Applicant: CANON KABUSHIKI KAISHA, Tokyo (JP)

(72) Inventor: KINA ITAKURA, Kanagawa (JP)

(21) Appl. No.: 19/391,848

(22) Filed: Nov. 17, 2025

(30) Foreign Application Priority Data
Nov. 22, 2024 (JP) 2024-203825

(51) Int. Cl. H04N 13/111; H04N 13/128; H04N 13/344; H04N 13/366; H04N 13/398

(52) U.S. Cl. CPC H04N 13/111; H04N 13/128; H04N 13/366; H04N 13/398; H04N 13/344

(57) ABSTRACT

A stereo image data acquiring unit acquires a sub-stereo image to be displayed within a main stereo image, and captured image information regarding the sub-stereo image. An HMD information acquiring unit acquires HMD information of an HMD to be used. A screen information determining unit determines, based on the sub-stereo image and the captured image information, screen information including a size of a planar screen for displaying the entire sub-stereo image and a distance from the planar screen to an observation viewpoint. A display image generating unit generates a main stereo image for displaying on the HMD based on the acquired sub-stereo image, the acquired HMD information, and the acquired screen information. A display control unit subjects the acquired main stereo image to conversion processing required for displaying the main stereo image on the HMD, and outputs the converted main stereo image to the HMD.

### BACKGROUND

### Field of the Technology

The present disclosure relates to image processing technology for generating stereo images.

### Description of the Related Art

In recent years, opportunities for observing video content using a head-mounted display (HMD) are increasing. When using an HMD to observe stereo images with parallax taken from different positions on the left and right, the observer observes images in which stereo images are displayed on a virtual planar screen placed within a virtual space or virtual reality space. At such time, the observer can view a stereoscopic image in which an object included in the stereo images appears to protrude from or recede into, the virtual planar screen. The way in which three-dimensional appearance is perceived when a stereo image is observed varies depending on the image capture conditions such as the distance between the left and right lenses (baseline length) and the angle of view when capturing the stereo image, and the observation conditions such as the distance to and size of the virtual planar screen.

International Publication No. WO2012/128178 discloses a lens system that calculates a baseline length that is suitable for perceiving a designated degree of three-dimensional appearance, and makes it possible to take stereo images with the calculated baseline length. An observer can observe stereo images obtained by capturing images in this manner with a designated degree of three-dimensional appearance by observing the stereo images under appropriate observation conditions. When displaying a sub-stereo image within a main stereo image, observation conditions for the sub-stereo image can be set arbitrarily by setting the position and size of the sub-stereo image to be placed in a three-dimensional space reconstructed by the main stereo image.

### SUMMARY

The present disclosure is characterized by at least one memory and at least one processor configured to: acquire a first stereo image having parallax for realizing stereoscopic vision, and parameters including information corresponding to an angle of view of the first stereo image when the first stereo image is generated; and generate a second stereo image based on the first stereo image and the parameters, wherein the at least one processor is further configured to generate the second stereo image such that an angle of view of a display region for displaying all of the first stereo image from an observation viewpoint in a three-dimensional space reconstructed by the second stereo image is set based on an angle of view of the first stereo image.

Features of the present disclosure will become apparent from the following description of embodiments with reference to the attached drawings. The following description of embodiments are described by way of example.

### BRIEF DESCRIPTION OF THE DRAWINGS

FIG. 1A to FIG. 1D are views for describing the principle by which three-dimensional appearance is perceived from a stereo image;

FIG. 2A is a view illustrating an example of the configuration of an image display system that uses an HMD;

FIG. 2B is a view illustrating an example of the hardware configuration of an image processing apparatus;

FIG. 3 is a block diagram illustrating an example of the software configuration of an image processing apparatus of Embodiment 1;

FIG. 4 is a flowchart for describing processing of the image processing apparatus of Embodiment 1;

FIG. 5A to FIG. 5C are views for describing the relation between an angle of view of a stereo image and the size and position of a screen that displays the stereo image;

FIG. 6 is a view for describing the relation between a virtual planar screen in a three-dimensional space reconstructed by a stereo image, and an observer;

FIG. 7 is a block diagram illustrating an example of the software configuration of an image processing apparatus of Embodiment 2;

FIG. 8 is a flowchart for describing processing of the image processing apparatus of Embodiment 2;

FIG. 9 is a block diagram illustrating the configuration of an image processing apparatus of Embodiment 3; and

FIG. 10 is a flowchart illustrating the flow of processing of the image processing apparatus of Embodiment 3.

### DESCRIPTION OF THE EMBODIMENTS

The technology described in International Publication No. WO2012/128178 requires an observer to identify and set appropriate observation conditions. However, there is a problem that if the observer cannot identify appropriate observation conditions, the three-dimensional appearance of the stereo image will differ from what the observer had intended, and the natural three-dimensional appearance will be impaired.

Hereinafter, embodiments of the present disclosure are described with reference to the accompanying drawings. Note that, the following embodiments are not intended to limit the present disclosure and not all combinations of characteristics described in the present embodiments are necessarily essential for the solution of the present disclosure. Furthermore, the same or similar components and configurations are denoted by the same signs.

### Embodiment 1

In Embodiment 1, when a sub-stereo image is to be displayed in a main stereo image that is displayed on an HMD, a display region for the entire sub-stereo image in the main stereo image is set based on parameters including information corresponding to an angle of view of an image capturing apparatus that took the sub-stereo image. More specifically, a virtual planar screen is arranged for displaying the entire sub-stereo image in a three-dimensional space reconstructed by the main stereo image. Further, an angle of view of the virtual planar screen from an observation viewpoint in the reconstructed three-dimensional space is set so as to be equal to an angle of view of the sub-stereo image at the time of image capturing. Note that, even if the angle of view of the virtual planar screen from the observation viewpoint and the angle of view of the sub-stereo image are not perfectly equal, there is an effect of making the three-dimensional appearance a more natural three-dimensional appearance. Further, although in the present embodiment an HMD is used as a display apparatus that displays the main stereo image, the display apparatus is not limited to an HMD, and any display apparatus which is capable of displaying each image of a stereo image individually to the left and right eyes may be used.

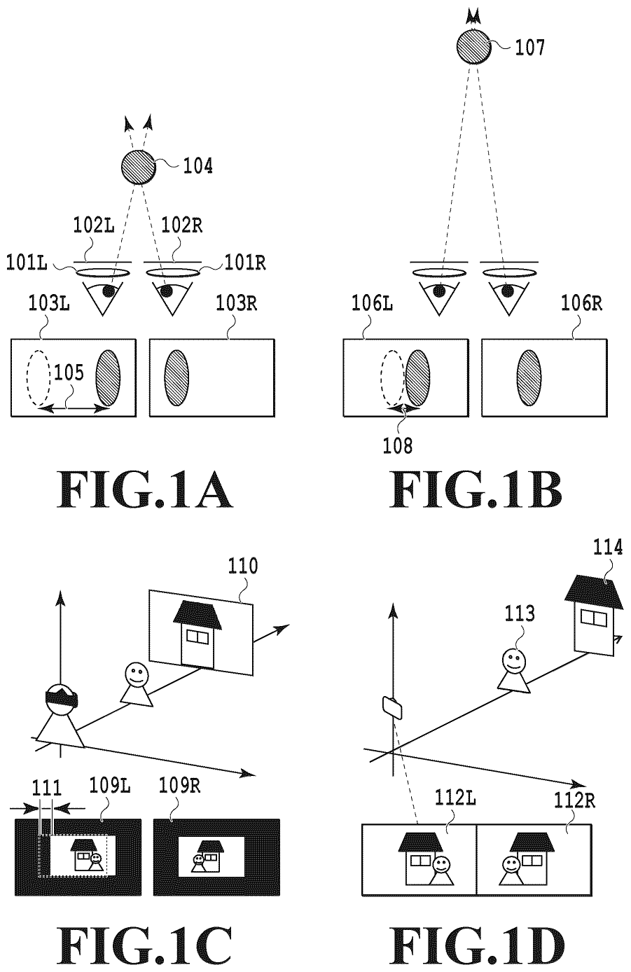

First, using FIG. 1A to FIG. 1D, the principle by which an observer perceives a three-dimensional appearance when observing a stereo image having parallax for realizing stereoscopic vision with an HMD will be described.

As illustrated in FIG. 1A, in an HMD, lenses 101L/101R and panels 102L/102R are arranged in front of the left and right eyes, respectively. An observer wearing the HMD can perceive an image as a virtual image by viewing the panels 102L/102R through the lenses 101L/101R with each of the left and right eyes. At such time, by displaying different images with parallax on the panels 102L/102R, the observer perceives a three-dimensional appearance in the virtual image due to binocular parallax. The position of the virtual image will vary depending on the amount of parallax between the images displayed on the panels 102L/102R. For example, as illustrated in FIG. 1A, in a case where the positions at which the same object 104 appears in an image for the left eye 103L and an image for the right eye 103R differ significantly and consequently parallax 105 is large, the observer perceives the object 104 as being present at a relatively close position. In contrast, as illustrated in FIG. 1B, in a case where the positions at which the same object 107 appears in an image for the left eye 106L and an image for the right eye 106R do not differ significantly and consequently parallax 108 is small, the observer perceives the object 107 as being present at a relatively distant position.

When a person wearing the HMD observes a stereo image displayed on the panels of the HMD, the person perceives a three-dimensional virtual space or virtual reality space reconstructed by the stereo image. When displaying a sub-stereo image within a main stereo image displayed by the HMD, as illustrated in FIG. 1C, the stereo image is displayed on a planar screen 110 placed in a three-dimensional space reconstructed by the main stereo image. The planar screen 110 is placed at a finite distance from the observation viewpoint in the reconstructed three-dimensional space. Consequently, in the display region of the planar screen 110 of images 109L/109R displayed on the panels 102L/102R, parallax 111 exists that corresponds to the distance from the planar screen 110 to the observation viewpoint. At this time, the image displayed in the display region of the planar screen 110 that is displayed on the panel 102L for the left eye is an image for the left eye of the sub-stereo image. Conversely, the image displayed in the display region of the planar screen 110 that is displayed on the panel 102R for the right eye is an image for the right eye of the sub-stereo image. Therefore, the observer can perceive an image three-dimensionally as if an object is popping out at a distance corresponding to the parallax in the sub-stereo image relative to the planar screen 110. For example, consider a case where an HMD is used to observe a main stereo image displayed on the planar screen 110 as illustrated in FIG. 1C with a stereo image 112L/112R obtained by capturing images of a space as illustrated in FIG. 1D as a sub-stereo image. At such time, the observer perceives an object 113 that is at a relatively close distance to the image capturing apparatus and has parallax as being present at a closer distance than the planar screen 110. Further, with respect to an object 114 that is at a very far distance from the image capturing apparatus and has almost no parallax, the observer perceives the object 114 as being present at a distance that is approximately equal to the distance from the planar screen 110.

The above is a description of the principle by which, when a main stereo image 109L/109R is observed in a case where a sub-stereo image 112L/112R is displayed within the main stereo image 109L/109R, three-dimensional appearance is perceived in the sub-stereo image 112L/112R. In the present embodiment, based on this principle of how a three-dimensional appearance of a sub-stereo image is perceived, conditions are determined for a display region for displaying the entire sub-stereo image within the main stereo image.

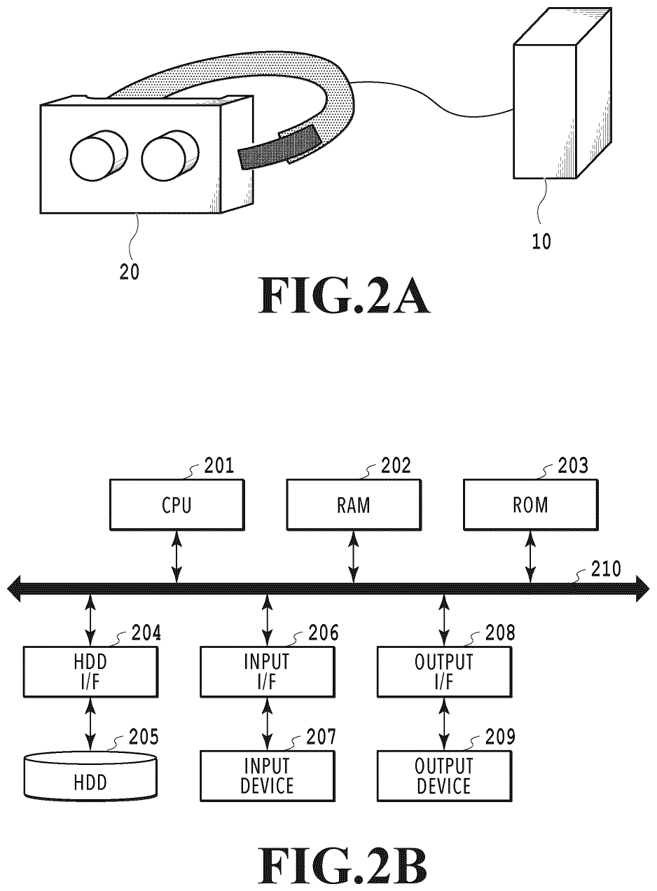

Hereunder, a specific configuration of the present embodiment is described. FIG. 2A is a view illustrating an example of the configuration of an image display system that uses an HMD 20. The image display system illustrated in FIG. 2A is constituted by an image processing apparatus 10 that controls the HMD 20, and the HMD 20 that is a head-mounted type display apparatus. Although a system configuration in which the image processing apparatus 10 is independent from the HMD 20 is described in the present embodiment, a configuration such as an integrated-type HMD system in which the image processing apparatus 10 is included inside the HMD 20 may also be adopted.

An example of the hardware configuration of the image processing apparatus 10 is shown in FIG. 2B. In FIG. 2B, a CPU 201 uses a RAM 202 as work memory to execute programs stored in a ROM 203 and a hard disk drive (HDD) 205 which is a secondary storage device, and controls the operation of each block (described later) via a system bus 210. An HDD interface (hereinafter, interface is written as “I/F”) 204 connects a secondary storage device such as the HDD 205 and an optical disk drive. The HDD I/F 204 is, for example, an I/F such as Serial ATA (SATA). The CPU 201 can read out data from the HDD 205 and write data to the HDD 205 via the HDD I/F 204. In addition, the CPU 201 can load data stored in the HDD 205 on the RAM 202, and conversely, can save data loaded on the RAM 202 in the HDD 205. The CPU 201 can then execute the data loaded on the RAM 202 as a program. An input I/F 206 can connect an input device such as a keyboard, a mouse, or an HMD controller. The input I/F 206 is, for example, a serial bus I/F such as USB or IEEE 1394. The CPU 201 reads data from an input device 207 via the input I/F 206. An output I/F 208 connects the image processing apparatus 10 to the HMD 20, which is an output device 209. The output I/F 208 is, for example, an image output I/F such as DVI or HDMI (registered trademark), and/or a serial bus I/F such as USB or IEEE 1394. The CPU 201 can send data to the output device 209, such as the HMD 20, via the output I/F 208 to display predetermined images. Further, the CPU 201 also receives information from the HMD 20, such as the position or orientation of the HMD 20 while the user is experiencing the images (hereinafter referred to as “HMD information”). The HMD information may be input via a mouse, a keyboard, a camera, or the like. Note that, although the image processing apparatus 10 includes other constituent elements in addition to the constituent elements described above, a description of the other constituent elements is omitted herein since the other constituent elements are not the focus of the present disclosure.

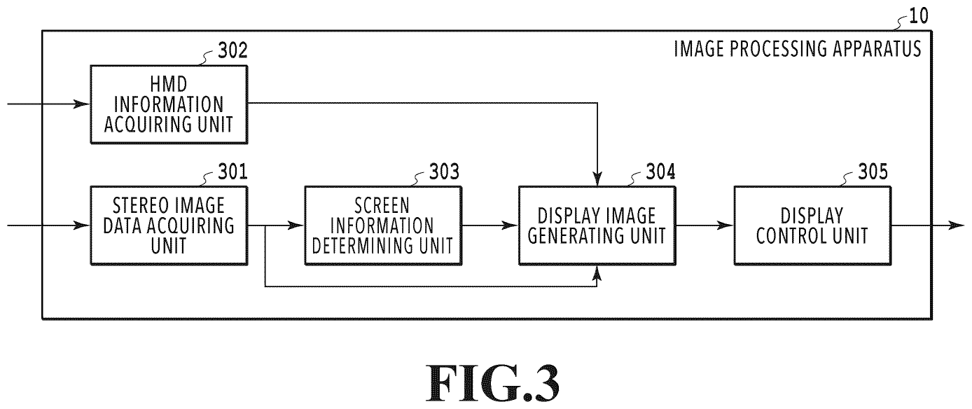

An example of the software configuration of the image processing apparatus 10 in the present embodiment is shown in FIG. 3. The image processing apparatus 10 according to the present embodiment has a stereo image data acquiring unit 301, an HMD information acquiring unit 302, a screen information determining unit 303, a display image generating unit 304, and a display control unit 305. Each of these components is described below.

The stereo image data acquiring unit 301 acquires a sub-stereo image to be displayed within a main stereo image, and captured image information which is parameters including information corresponding to the angle of view of an image capturing apparatus that took the sub-stereo image. The stereo image that the stereo image data acquiring unit 301 acquires may be a stereo image stored in the HDD 205 or a stereo image output from the image capturing apparatus immediately after capturing the image. The stereo image in the present embodiment is, for example, a stereo image having parallax that was taken using a standard lens with a 46-degree angle of view. The data format of the stereo image may be any format capable of representing two images having parallax, and for example MV-HEVC or the like as a data format for moving images may be used. The angle of view as photographic information may be information indicating the angle of view itself or information that can be calculated from other photographic information. In the present exemplary embodiment, these are regarded as information corresponding to the angle of view. Further, the angle of view is not limited to the aforementioned angle of view, and may be a narrower angle of view such as an angle of view of a telephoto lens or a wider angle of view such as an angle of view of a wide-angle lens. Note that, although in the present embodiment it is assumed that the stereo images are captured images obtained by capturing images using an image capturing apparatus, the stereo images may also be CG images. In a case where a sub-stereo image is a CG image, the captured image information is regarded as being parameters relating to the viewpoint used for rendering the CG image.

Further, the stereo image data acquiring unit 301 also acquires captured image information that is information relating to the image capture conditions when capturing the images corresponding to the stereo image that is acquired. The captured image information includes at least a baseline length representing the distance between the lenses of the left and right image capturing apparatuses and the angle of view (horizontal angle of view) in the horizontal direction (baseline length direction). The horizontal angle of view may be a diagonal angle of view. In the present embodiment, the captured image information is stored as metadata of the stereo image, and the stereo image data acquiring unit 301 acquires the captured image information by reading the metadata of the stereo image. Note that, if the horizontal angle of view is stored in the metadata, the horizontal angle of view is used as-is as captured image information. However, in a case where the sensor size and focal length are stored in the metadata, the horizontal angle of view is calculated from that information. It is possible to calculate the horizontal angle of view based on the sensor size and focal length using the formula 2×atan(cs/2/f), where cs is the sensor size in the horizontal direction and f is the focal length. The stereo image and captured image information acquired by the stereo image data acquiring unit 301 are output to the screen information determining unit 303 and the display image generating unit 304.

The HMD information acquiring unit 302 acquires, as HMD information, information indicating the position and orientation of the HMD 20 when the wearer of the HMD 20 is experiencing a virtual space or a virtual reality space. The position of the HMD 20 in the HMD information is expressed in a three-dimensional coordinate system representing the three-dimensional space reconstructed by the stereo image displayed on the HMD 20. In the present embodiment, the three-dimensional coordinate system uses an x-axis that represents the spread in the lateral direction (baseline direction), a y-axis that represents the spread in the height direction, and a z-axis that represents the spread in the depth direction relative to the position and orientation of the HMD 20 at the start of operation as a reference. Apart from the position and orientation of the HMD 20 at the start of operation, the position and orientation that serve as a reference may be the position and orientation of the HMD 20 when a function to reset the position/display that is arranged in the HMD 20 is executed. Further, the HMD 20 has a plurality of RGB cameras and an inertial measurement unit (IMU) in order to realize position tracking by an inside-out method. The IMU is a device that detects three-dimensional inertial motion (translational motion and rotational motion along three orthogonal axial directions), and is constituted by a gyro sensor that detects rotational motion and an acceleration sensor that detects translational motion. The orientation of the HMD 20 is expressed by the IMU by using a 3×3 rotation matrix in three-dimensional space, as well as roll, pitch, and yaw. Note that the method for expressing the orientation is not limited to this method, and a different expression method such as quaternions may also be used. The HMD information that the HMD information acquiring unit 302 acquired is output to the display image generating unit 304.

The screen information determining unit 303 determines screen information relating to a virtual planar screen on which the entire sub-stereo image is to be displayed, based on the stereo image and captured image information that were input from the stereo image data acquiring unit 301. The screen information includes the size of the planar screen and the distance from the planar screen to the observation viewpoint. The size of the planar screen is represented by two types of scalar values which indicate the respective lengths in the horizontal direction and the perpendicular direction. The distance from the planar screen to the observation viewpoint is the z-coordinate value in the three-dimensional coordinate system representing the three-dimensional space reconstructed by the stereo images described above, and is expressed as the distance in the z-axis direction from the origin of the three-dimensional coordinate system. The screen information determined by the screen information determining unit 303 is output to the display image generating unit 304.

The display image generating unit 304 generates a main stereo image to be displayed by the HMD 20 based on the sub-stereo image, the HMD information, and the screen information. This main stereo image is a rendering image of a three-dimensional space in which a display region for displaying the entire sub-stereo image is arranged as described above, and consists of two images for displaying on the entire left and right panels of the HMD 20. The main stereo image generated by the display image generating unit 304 is output to the display control unit 305.

The display control unit 305 converts the main stereo image that was input from the display image generating unit 304 into an image that is suitable for observation with the HMD 20, and outputs the converted image to the HMD 20. The conversion in this case is color conversion processing suitable for the built-in panels of the HMD 20, distortion correction processing for correcting distortion of the eyepieces of the HMD 20, or the like.

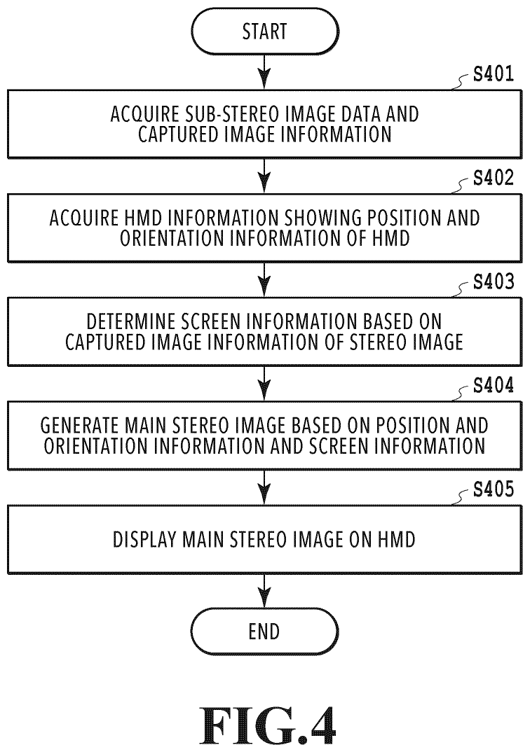

FIG. 4 is a flowchart for describing main stereo image data generation processing in the present embodiment. The image processing apparatus 10 executes the series of processes shown in the flowchart of FIG. 4 by having the CPU 201 execute a program stored in the ROM 203 using the RAM 202 as a work memory. Note that, it is not necessary for all of the processes described hereunder to be executed by the CPU 201, and the image processing apparatus 10 may be configured so that some or all of the processing is performed by one or a plurality of processing circuits other than the CPU 201. In the present embodiment, moving images that have been taken and stored in advance are read from the HDD 205, and processing is started in response to a display start instruction in the HMD 20, and the processing is executed in frame units. Note that, in the following flowcharts, each step is denoted by the character “S”.

In S401, the stereo image data acquiring unit 301 acquires the sub-stereo image to be displayed within the main stereo image, and the captured image information with respect to the sub-stereo image. The acquired stereo image and captured image information are output to the screen information determining unit 303 and the display image generating unit 304.

In S402, the HMD information acquiring unit 302 acquires HMD information of the HMD 20 to be used. The acquired HMD information is output to the display image generating unit 304.

In S403, based on the sub-stereo image and the captured image information, the screen information determining unit 303 determines screen information including the size of the planar screen for displaying the entire sub-stereo image and the distance from the planar screen to the observation viewpoint. Specifically, the screen information determining unit 303 determines the size of the planar screen and the distance from the planar screen to the observation viewpoint in the screen information so that the horizontal angle of view of the sub-stereo image in the captured image information and the horizontal angle of view of the planar screen on which the observer observes the main stereo image are equal.

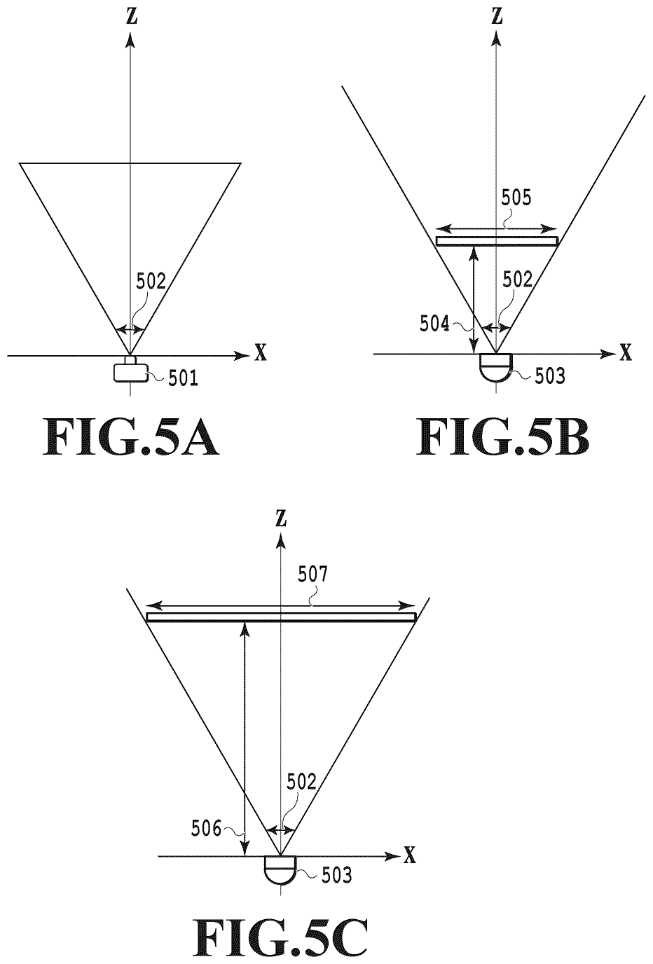

FIGS. 5A to 5C are views for describing the relation between image capture conditions and observation conditions. The views in FIGS. 5A to 5C are bird's-eye views in which an image capturing apparatus 501 and an observer 503 are seen from the perpendicular direction (y-axis direction). FIG. 5A illustrates a horizontal angle of view 502 at a time when a stereo image is taken by the image capturing apparatus 501. Further, FIGS. 5B and 5C illustrate a horizontal angle of view 502 of a virtual planar screen at an observation viewpoint where the observer 503 observes the virtual planar screen in the present embodiment. Thus, in the present embodiment a horizontal angle of view 502 of the planar screen that the observer 503 observes is made equal to the horizontal angle of view 502 of the image capturing apparatus 501 during image capturing. Here, the horizontal angle of view of the planar screen that the observer observes varies depending on the relation between the size of the planar screen and the distance from the planar screen to the observation viewpoint. For example, in FIG. 5C, a planar screen 507 that is a larger size than a planar screen 505 illustrated in FIG. 5B is placed at a distance 506 from the observation viewpoint which is a greater distance than a distance 504 from the planar screen to the observation viewpoint in FIG. 5B. In both FIG. 5B and FIG. 5C, the horizontal angle of view 502 during image capturing is the same as the horizontal angle of view 502 with respect to the planar screens 505 and 507 that are observed from the observation viewpoint. According to the present embodiment, first, one value among the length in the horizontal direction of the virtual planar screen that is observed and the distance from the planar screen to the observation viewpoint is determined. Thereafter, the other value is determined so that the horizontal angle of view during image capturing and the horizontal angle of view of the virtual planar screen that is observed become equal. For example, if the length of the planar screen in the horizontal direction is represented by “scw”, the distance from the planar screen to the observation viewpoint is set to scw/2/tan(θ/2). Here, θ is the horizontal angle of view in the captured image information. Conversely, if the distance from the planar screen to the observation viewpoint is represented by “d”, the length of the planar screen in the horizontal direction is set to 2×d×tan(θ/2). The length of the planar screen in the horizontal direction or the distance from the planar screen to the observation viewpoint that is to be fixed may be any value, such as a value which was determined in advance or a value which was input by the observer. The length of the planar screen in the perpendicular direction is determined so that the length of the planar screen in the horizontal direction and the aspect ratio of the sub-stereo image to be displayed thereon match the aspect ratio of the sub-stereo image during image capturing. Specifically, the pixel count in the horizontal direction imw and the pixel count in the perpendicular direction imh of the sub-stereo image to be displayed on the planar screen are used to determine the length of the planar screen in the perpendicular direction by the formula scw/imw×imh. The screen information consisting of the size of the planar screen and the distance from the planar screen to the observation viewpoint determined as described above is output to the display image generating unit 304.

Note that, although in the method described above the horizontal angle of view of the planar screen to be observed is determined so as to perfectly match the horizontal angle of view θ during image capturing, the present embodiment is not limited thereto, and the horizontal angle of view of the planar screen to be observed may be determined so that the two angles of view are approximately equal to each other. In such case, an interval of possible values that the horizontal angle of view of the planar screen to be observed can take is defined, the acquired horizontal angle of view θ during image capturing is converted to a closest angle of view θ′ that can be taken within the defined interval, and the screen information is determined using the formula described above based on the angle of view θ′. For example, in a case where the interval of possible values the horizontal angle of view θ′ of the planar screen can take is defined as 5 degrees, if the horizontal angle of view θ during image capturing is 46 degrees, the angle of view θ′ after conversion will be 45 degrees. Note that, a method for determining the angle of view during observation so as to be approximately the same as the angle of view during image capturing is not limited to the foregoing method. For example, the angle of view during observation may be determined by another method such as defining an interval of possible values which the size of the planar screen or the distance from the planar screen to the observation viewpoint can take, and then converting a value of the screen information determined based on the stereo image and the captured image information to the closest value to that value which it is possible to take.

In S404, the display image generating unit 304 generates a main stereo image for displaying on the HMD 20 based on the sub-stereo image acquired in S401, the HMD information acquired in S402, and the screen information acquired in S403. Specifically, first, the display image generating unit 304 calculates the line-of-sight direction of the viewpoint of the observer (observation viewpoint) wearing the HMD 20 in the three-dimensional space reconstructed by the main stereo image as a three-dimensional unit vector based on orientation information of the HMD 20 included in the HMD information. Then, based on position information of the HMD 20 included in the HMD information and the direction of the calculated three-dimensional unit vector (line-of-sight direction of the observation viewpoint), the display image generating unit 304 renders a main stereo image representing the view from the observation viewpoint in accordance with the display angle of view of the HMD 20. The display angle of view at such time is a fixed value that depends on the HMD 20, and is determined by the viewing angle and panel resolution of the display device. Further, rendering is a process of generating a perspective projection image from a three-dimensional space, and a general three-dimensional rendering method may be used.

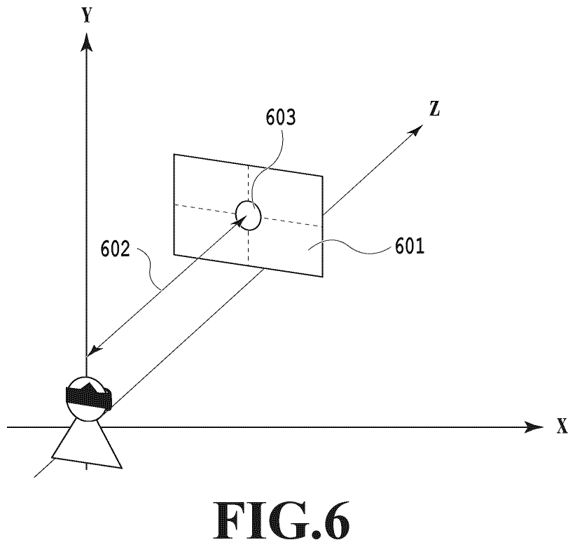

FIG. 6 is a view illustrating a virtual planar screen placed in a three-dimensional space reconstructed by a main stereo image that an observer observes through the HMD 20. This virtual planar screen 601 is set to a size and a distance 602 from the observation viewpoint which are set based on the screen information, and the sub-stereo image acquired in S401 is displayed thereon. In the present embodiment, the direction in which the virtual planar screen 601 is placed is the z-axis direction in the aforementioned three-dimensional coordinate system, and when expressed as a unit direction vector in the three-dimensional coordinate system, v=(0,0,1). That is, the virtual planar screen 601 is placed in the front direction of the observation viewpoint in a reference state upon defining the three-dimensional coordinate system. Further, a predetermined height h is used as the height of the virtual planar screen 601 in the present embodiment. When expressing the position of a center 603 of the planar screen as a three-dimensional coordinate value in the three-dimensional coordinate system, the coordinate value is (0, h, d+pz). Here, d is the distance 602 from the planar screen to the observation viewpoint in the screen information, and pz is the position of the observation viewpoint in the z-axis direction in the HMD information. Note that, the direction and position of the virtual planar screen 601 are not limited to the example described above as long as the size of the virtual planar screen 601 and the distance from the observation viewpoint match the screen information. For example, a configuration may be adopted so that even if the line-of-sight direction of the observation viewpoint changes, the virtual planar screen 601 is always placed directly in front of the line-of-sight direction of the observation viewpoint. In such case, it suffices to calculate the line-of-sight direction of the observation viewpoint as a three-dimensional unit vector from the orientation information included in the HMD information, and to place the virtual planar screen 601 at a position which is separated from the observation viewpoint by the distance designated in the screen information in the direction of the three-dimensional unit vector. Further, with regard to the height of the center of the virtual planar screen 601, the height may be set so as to be the same as the height of the observation viewpoint, and in such case the position coordinates of the center of the virtual planar screen 601 are (0, py, d+pz). Here, py is the position of the observation viewpoint in the y-axis direction in the HMD information. Note that, as mentioned above, the image displayed on the virtual planar screen 601 will differ between the image for the left eye and the image for the right eye of the main stereo image. When generating an image for the left eye of the main stereo image for displaying on the panel for the left eye, the image for the left eye of the sub-stereo image is displayed on the virtual planar screen. When generating an image for the right eye of the main stereo image for displaying on the panel for the right eye, the image for the right eye of the sub-stereo image is displayed on the virtual planar screen 601.

In S405, the display control unit 305 subjects the main stereo image acquired in S404 to conversion processing required for displaying the main stereo image on the HMD 20, and then outputs the converted main stereo image to the HMD 20. The HMD 20 displays the converted main stereo image received from the image processing apparatus 10 on the panels 102L/103R. When the processing in S405 is completed, the series of processes ends.

The above is a description of processing which the image processing apparatus 10 executes in the present embodiment. The processing described above is for a case where the processing is started in response to an instruction to start operation of the HMD 20 and the processing is executed in frame units. However, the processing is not limited to the case described above. For example, a configuration may be adopted so that the present processing is executed only at a timing at which an instruction to start playback of a stereo image by the observer is executed. In such case, the size of the planar screen 601 and the distance from the planar screen 601 to the observation viewpoint will not be changed and will remain fixed until playback of the acquired sub-stereo image is completed, or until another sub-stereo image is acquired and an instruction to start playback of the acquired other sub-stereo image is executed.

As described above, in the present embodiment, when displaying a sub-stereo image within a main stereo image to be observed using the HMD 20, the horizontal angle of view of a planar screen for displaying the entire sub-stereo image is made equal to the horizontal angle of view of the sub-stereo image during image capturing. By this means, the observer can observe an object included in the sub-stereo image with a natural three-dimensional appearance.

### Embodiment 2

In Embodiment 1, captured image information with respect to a sub-stereo image to be displayed within a main stereo image is used as a basis for determining information for a planar screen for displaying the entire sub-stereo image that is to be placed in a three-dimensional space reconstructed by the main stereo image. Specifically, the size of a virtual planar screen and the distance from the virtual planar screen to the observation viewpoint are determined so that the horizontal angle of view of the sub-stereo image during image capturing and the horizontal angle of view of the virtual planar screen are approximately equal.

In contrast, in Embodiment 2, a maximum angle of view and a minimum angle of view are determined in relation to the horizontal angle of view of a virtual planar screen used for observation. Furthermore, processing for determining screen information is added so as to enable observation with the horizontal angle of view of the virtual planar screen that realizes the most natural three-dimensional appearance in the range between the maximum angle of view and the minimum angle of view.

In Embodiment 1, in a case where the horizontal angle of view of the sub-stereo image is a narrow angle of view, such as 20 degrees, the horizontal angle of view of the planar screen for displaying the entire sub-stereo image also becomes the same narrow angle of view of 20 degrees. In this case, depending on the content of the sub-stereo image displayed on the planar screen, the image may become too small and therefore be difficult to see. Conversely, in a case where the horizontal angle of view of the sub-stereo image is a wide angle of view, such as 60 degrees, the horizontal angle of view of the planar screen also becomes a wide angle of view of 60 degrees. In this case also, depending on the HMD used for observation, the angle of view may exceed the viewing angle of the HMD and consequently it may be necessary to observe the sub-stereo image in a state in which a partial region of the sub-stereo image is missing. Therefore, in Embodiment 2, a minimum angle of view and a maximum angle of view are defined for the horizontal angle of view of the planar screen for displaying the entire sub-stereo image.

In Embodiment 2, in a case where the horizontal angle of view of a sub-stereo image to be displayed within a main stereo image is within a predetermined range between the minimum angle of view and the maximum angle of view, the screen information is determined in the same manner as in Embodiment 1.

On the other hand, in a case where the horizontal angle of view of the sub-stereo image is smaller than the minimum angle of view, the screen information is determined so that the horizontal angle of view of the planar screen for displaying the entire sub-stereo image becomes the minimum angle of view. At such time, the greater the difference is between the horizontal angle of view of the sub-stereo image and the minimum angle of view of the planar screen, the greater the possibility that the three-dimensional appearance obtained during observation will be unnatural, such as objects being perceived as thinner than they actually are. Therefore, in Embodiment 2, the distance from the planar screen to the observation viewpoint is fixed to a predetermined distance corresponding to the minimum angle of view, and the size of the planar screen is determined so that the horizontal angle of view of the planar screen at that position becomes the minimum angle of view. By fixing the distance from the planar screen to the observation viewpoint to the distance corresponding to the minimum angle of view, the amount by which objects included in the sub-stereo image appear to pop out from the planar screen is reduced, and it can thus be made less likely for objects to be perceived as being unnaturally thin during observation.

Furthermore, in a case where the horizontal angle of view of the sub-stereo image during image capturing is greater than the maximum angle of view of the planar screen for displaying the sub-stereo image, screen information is determined so that the horizontal angle of view of the planar screen becomes the maximum angle of view. At such time, the greater the difference is between the horizontal angle of view of the sub-stereo image and the maximum angle of view, the greater the possibility that the three-dimensional appearance obtained during observation will be unnatural, such as objects being perceived as thicker than they actually are. Therefore, in Embodiment 2, the distance from the planar screen to the observation viewpoint is fixed to a predetermined distance corresponding to the maximum angle of view, and the size of the virtual planar screen is determined so that the horizontal angle of view of the virtual planar screen during observation becomes the maximum angle of view. By fixing the distance from the planar screen to the observation viewpoint to the distance corresponding to the maximum angle of view, the amount by which objects included in the sub-stereo image appear to pop out from the planar screen is increased, and it can thus be made less likely for objects to be perceived as being unnaturally thick during observation.

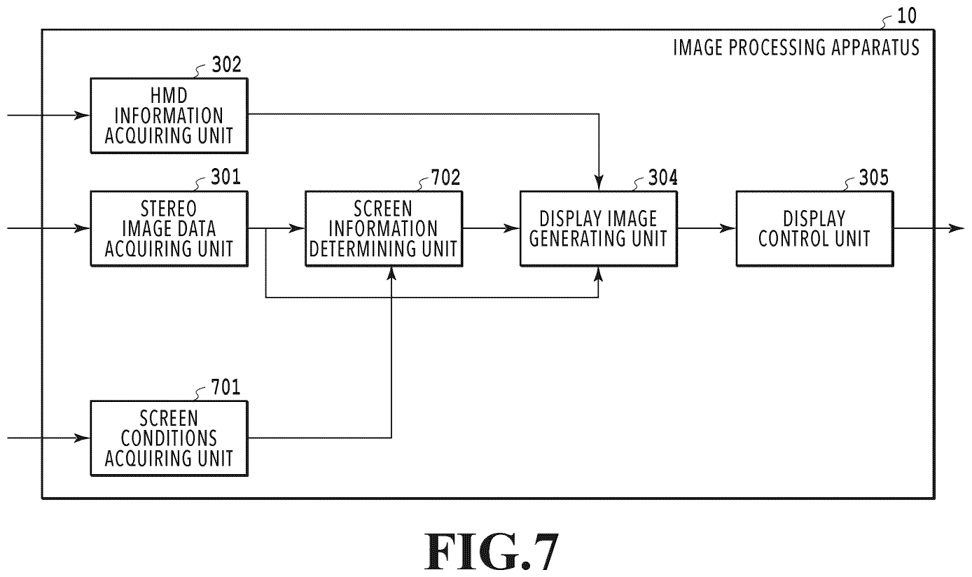

FIG. 7 is a block diagram illustrating the configuration of the image processing apparatus 10 in the present embodiment. The image processing apparatus 10 according to the present embodiment has the stereo image data acquiring unit 301, a screen conditions acquiring unit 701, a screen information determining unit 702, the HMD information acquiring unit 302, the display image generating unit 304, and the display control unit 305. Each of these components is described below. Components which are the same as those in Embodiment 1 are denoted by the same signs as in Embodiment 1, and a description thereof is omitted hereunder.

The screen conditions acquiring unit 701 acquires predetermined screen conditions information corresponding to the HMD 20 from the HDD 205. In the present embodiment, the screen conditions information is information pertaining to the minimum angle of view and maximum angle of view in the horizontal direction of a planar screen for displaying an entire sub-stereo image, and the distances from the planar screen to the observation viewpoints corresponding to these angles of view. The distances from the two observation viewpoints corresponding to the minimum angle of view and the maximum angle of view are distances that are utilized when the horizontal angle of view during image capturing of the stereo image is smaller than the minimum angle of view or is larger than the maximum angle of view.

The minimum angle of view and the maximum angle of view can be set arbitrarily. For example, 30 degrees which is said to be the central viewing angle where the sensitivity of the human field of vision is highest may be set as the minimum angle of view, and 50 degrees which is the average maximum viewing angle of a glasses-type HMD may be set as the maximum angle of view. As another example, the viewing angle of the HMD 20 to be utilized may be set as the maximum angle of view, or a configuration may be adopted that enables the observer to freely select the minimum angle of view and the maximum angle of view. Although the shorter that the distance from the observation viewpoint corresponding to the minimum angle of view of the planar screen is, the better it is, if the distance is too short, in some cases an object that appears to protrude from the planar screen may be too close to the observer. If an object perceived as protruding outward is too close to the observer, it may be difficult for the observer to fuse the object. Therefore, an example of the distance from the observation viewpoint corresponding to the minimum angle of view of the planar screen that may be mentioned is 1 meter, which is a distance at which the observer can comfortably fuse images. The longer that the distance from the observation viewpoint corresponding to the maximum angle of view of the planar screen is, the better it is, and an example of the distance from the observation viewpoint corresponding to the maximum angle of view of the virtual planar screen that may be mentioned is 7 meters, which is considered to be the distance at which three-dimensional appearance is most readily perceived. The screen conditions information determined in this manner is stored in advance in the HDD 205, and the screen conditions acquiring unit 701 outputs the screen conditions information acquired from the HDD 205 to the screen information determining unit 702.

The screen information determining unit 702 determines screen information relating to the virtual planar screen based on the stereo image and captured image information that were input from the stereo image data acquiring unit 301, and the screen conditions information that was input from the screen conditions acquiring unit 701. The screen information which the screen information determining unit 702 determines is, similarly to Embodiment 1, the size of the virtual planar screen and the distance from the virtual planar screen to the observation viewpoint. The determined screen information is output to the display image generating unit 304.

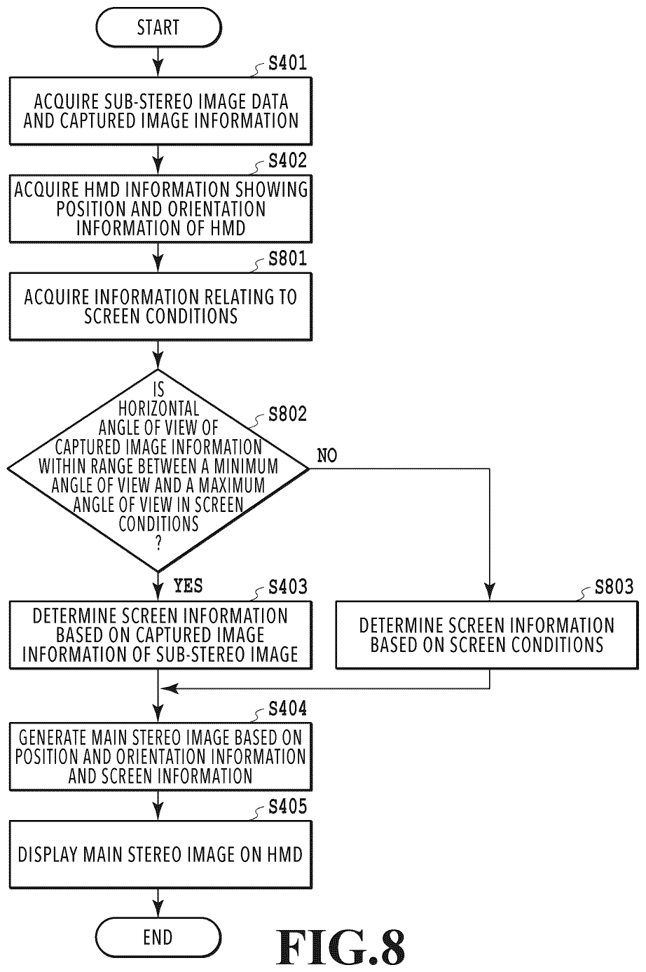

FIG. 8 is a flowchart for describing main stereo image data generation processing in Embodiment 2. In the flowchart, S401 to S405 are the same as in Embodiment 1, and hence a description of those steps is omitted here and only the processing in S801 to S803 which are added in Embodiment 2 is described.

In S801, the screen conditions acquiring unit 701 acquires the screen conditions information. The acquired screen conditions information is output to the screen information determining unit 702.

In S802, the screen information determining unit 702 compares the horizontal angle of view of the captured image information acquired from the stereo image data acquiring unit 301 with the minimum angle of view and maximum angle of view in the horizontal direction of the screen conditions information acquired from the screen conditions acquiring unit 701. If the horizontal angle of view of the captured image information is within the range between the minimum angle of view and maximum angle of view, the process proceeds to S403. If the horizontal angle of view of the captured image information is smaller than the minimum angle of view or is larger than the maximum angle of view, the process proceeds to S803.

In S803, the screen information determining unit 702 determines screen information based on the screen conditions information. Specifically, the screen information determining unit 702 determines the size of the planar screen in the screen information so that the minimum angle of view or maximum angle of view in the horizontal direction in the screen conditions information and the horizontal angle of view of the planar screen for displaying the entire sub-stereo image are approximately equal. Further, the screen information determining unit 702 determines the distance from the planar screen to the observation viewpoint in the screen information so as to be a distance that corresponds to the minimum angle of view or maximum angle of view included in the screen conditions information. If the horizontal angle of view of the captured image information is smaller than the minimum angle of view, the minimum angle of view is used as the horizontal angle of view of the planar screen, and the distance for the minimum angle of view is used as the distance from the planar screen to the observation viewpoint. Conversely, if the horizontal angle of view of the captured image information is larger than the maximum angle of view, the maximum angle of view is used as the horizontal angle of view of the planar screen, and the distance for the maximum angle of view is used as the distance from the planar screen to the observation viewpoint. Note that, the method for calculating the size of the planar screen is the same as the method described in Embodiment 1, and hence a description thereof is omitted here. The screen information determining unit 702 outputs screen information that consists of the determined size of the planar screen and distance from the planar screen to the observation viewpoint to the display image generating unit 304.

The above is a description of processing performed by the image processing apparatus 10 of Embodiment 2. In Embodiment 2, the horizontal angle of view of the planar screen for displaying the sub-stereo image to be displayed within the main stereo image is determined based on a predetermined maximum angle of view and minimum angle of view in addition to the horizontal angle of view of the sub-stereo image during image capturing. This allows the observer to comfortably fuse the stereo images and obtain a natural three-dimensional appearance in a state in which perceptual sensitivity with respect to the three-dimensional appearance is also high.

Note that, although in the present embodiment both a minimum angle of view and a maximum angle of view are set, a configuration may also be adopted in which only either one of the minimum angle of view and the maximum angle of view is set.

### Embodiment 3

In Embodiment 3, the captured image information for the sub-stereo image includes a baseline length, which is the distance between the two left and right lenses of the image capturing apparatus. In addition, information regarding the interpupillary distance that is the distance between the left and right eyes of the observer is newly acquired, and screen information for the planar screen for displaying the entire sub-stereo image is determined based on the captured image information and the information regarding the interpupillary distance. Specifically, the screen information is determined so that the horizontal angle of view of the planar screen is approximately equal to a corrected angle of view that is obtained by scaling the horizontal angle of view of the sub-stereo image during image capturing by a ratio between the baseline length and the interpupillary distance.

Even when the horizontal angle of view of the sub-stereo image during image capturing and the horizontal angle of view of the virtual planar screen are the same as in Embodiment 1, if the baseline length of the image capturing apparatus is significantly different from the interpupillary distance of the observer, the three-dimensional appearance of an object included in the sub-stereo image may be unnatural. For example, in a case where the baseline length is shorter than the interpupillary distance, there is a possibility that an object will be perceived as excessively thinner than it actually is or the like, and consequently the natural three-dimensional appearance will be impaired. Conversely, in a case where the baseline length is longer than the interpupillary distance, there is a possibility that an object will be perceived as excessively thicker than it actually is or the like, and consequently the natural three-dimensional appearance will be impaired. Therefore, in Embodiment 3, the screen information is determined so that the horizontal angle of view of the planar screen is approximately equal to a corrected angle of view that is obtained by scaling the horizontal angle of view of the sub-stereo image during image capturing by a ratio between the baseline length and the interpupillary distance. By this means, even in a case where the baseline length with respect to the sub-stereo image and the interpupillary distance of the observer differ from each other, the image can be observed with a more natural three-dimensional appearance.

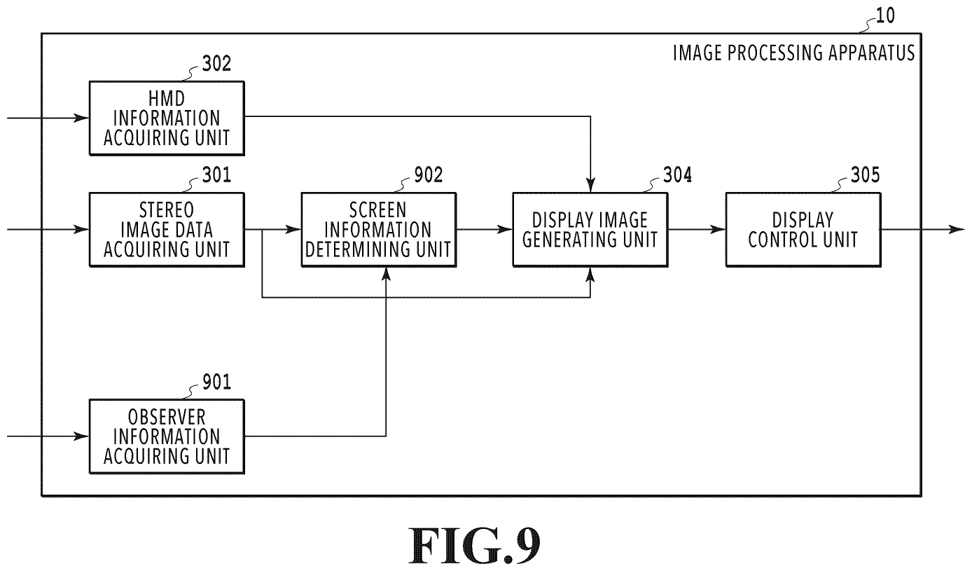

A software configuration example of the image processing apparatus 10 in the present embodiment is illustrated in FIG. 9. The image processing apparatus 10 of the present embodiment has the stereo image data acquiring unit 301, an observer information acquiring unit 901, a screen information determining unit 902, the HMD information acquiring unit 302, the display image generating unit 304, and the display control unit 305. Each of these components is described below. Components which are the same as those in Embodiment 1 are denoted by the same signs as in Embodiment 1, and a description thereof is omitted hereunder.

The observer information acquiring unit 901 acquires information regarding the interpupillary distance of the observer from the HDD 205. For example, the information regarding the interpupillary distance is a scalar value that represents the interpupillary distance of the observer, such as 65 mm. Since the HMD 20 is generally equipped with a mechanism that can adjust the distance between the eyepieces to match the interpupillary distance of the observer, in the present embodiment the distance between the eyepieces of the HMD 20 is acquired as the information regarding the interpupillary distance of the observer. Note that, a method for acquiring the interpupillary distance of the observer is not limited to the aforementioned method, and various other methods can be utilized, such as a method that uses a value input by the observer, or a method that estimates the interpupillary distance based on information from an eye tracking camera attached to the HMD 20. The information regarding the interpupillary distance that the observer information acquiring unit 901 acquired is output to the screen information determining unit 902.

The screen information determining unit 902 determines screen information relating to the virtual planar screen based on the sub-stereo image and captured image information that were input from the stereo image data acquiring unit 301, and the interpupillary distance information that was input from the observer information acquiring unit 901. Similarly to Embodiment 1, the screen information is the size of a planar screen for displaying the entire sub-stereo image and the distance from the planar screen to the observation viewpoint. The screen information determining unit 902 outputs the determined screen information to the display image generating unit 304.

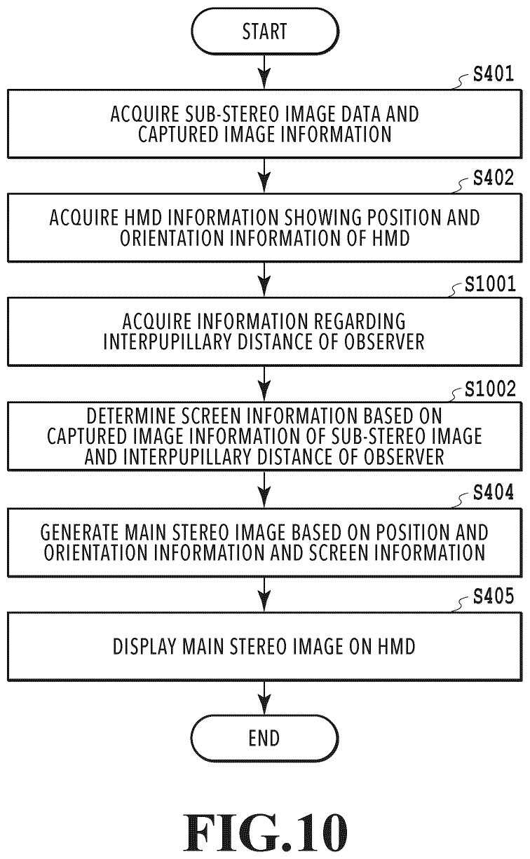

FIG. 10 is a flowchart for describing main stereo image data generation processing in the present embodiment. Since S401, S402, S404, and S405 are the same as in Embodiment 1, a description of those steps is omitted here, and only the processing in S1001 and S1002 which are added in Embodiment 3 is described. Note that, it is assumed that the baseline length of the image capturing apparatus using for capturing the image is included in the captured image information acquired in S401.

In S1001, the observer information acquiring unit 901 acquires the interpupillary distance information of the observer. The acquired information regarding the interpupillary distance is output to the screen information determining unit 902.

In S1002, the screen information determining unit 902 determines screen information based on the captured image information acquired from the stereo image data acquiring unit 301 and the information regarding the interpupillary distance acquired from the observer information acquiring unit 901. Specifically, the screen information determining unit 902 determines the screen information so that an angle of view obtained by scaling the horizontal angle of view of the sub-stereo image included in the captured image information by a ratio between the baseline length and the interpupillary distance, and the horizontal angle of view of the planar screen are approximately equal. When the horizontal angle of view of the captured image information is represented by “θ”, the baseline length is represented by “T”, and the interpupillary distance is represented by “e”, the horizontal angle of view φ of the virtual planar screen obtained by scaling by the ratio of the baseline length to the interpupillary distance is φ=θT÷e. In addition, the size of the planar screen and the distance from the planar screen to the observation viewpoint are determined using the method described in Embodiment 1 so that the horizontal angle of view of the planar screen becomes φ. The screen information determining unit 902 outputs the screen information consisting of the determined size of the planar screen and distance from the planar screen to the observation viewpoint to the display image generating unit 304.

The above is a description of processing which is additionally performed by the image processing apparatus 10 of Embodiment 3 relative to the processing of Embodiment 1. In Embodiment 3, information regarding the baseline length, which is the distance between the two left and right lenses at the time of capturing the sub-stereo image, is acquired as captured image information, and information regarding the interpupillary distance which is the distance between the left and right eyes of the observer is acquired. Then, by determining a planar screen on which to display the entire sub-stereo image based on the baseline length and the information regarding the interpupillary distance, the sub-stereo image can be observed with a more natural three-dimensional appearance even if the interpupillary distance of the observer differs from the baseline length of the image capturing apparatus.

Embodiments of the present disclosure are not limited to the exemplary embodiments described above, and various embodiments of the present disclosure are possible. For example, Embodiment 2 and Embodiment 3 may be used in combination.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be arranged to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, it is possible to readily observe stereo images with a natural three-dimensional appearance.

This application claims the benefit of Japanese Patent Application No. 2024-203825, filed Nov. 22, 2024, which is hereby incorporated by reference herein in its entirety.

What is claimed is:

1. An image processing apparatus comprising at least one memory and at least one processor configured to:
acquire a first stereo image having parallax for realizing stereoscopic vision, and parameters including information corresponding to an angle of view of the first stereo image; and
generate a second stereo image based on the first stereo image and the parameters,
wherein the at least one processor is further configured to generate the second stereo image such that an angle of view of a display region, for displaying all of the first stereo image from an observation viewpoint in a three-dimensional space reconstructed by the second stereo image, is set based on an angle of view of the first stereo image.

2. The image processing apparatus according to claim 1, wherein the angle of view of the first stereo image and the angle of view of the display region are angles of view in a horizontal direction.

3. The image processing apparatus according to claim 1, wherein the at least one processor is configured to generate the second stereo image so that a difference between the angle of view of the display region and the angle of view of the first stereo image is within a predetermined range.

4. The image processing apparatus according to claim 1, wherein the at least one processor is configured to generate the second stereo image so that the angle of view of the display region and the angle of view of the first stereo image are approximately equal.

5. The image processing apparatus according to claim 1, wherein the at least one processor is configured to generate the second stereo image in which a size of the display region and a distance from the display region to the observation viewpoint are set based on the angle of view of the display region.

6. The image processing apparatus according to claim 5, wherein the at least one processor
acquire conditions information including at least one of a minimum angle of view and a maximum angle of view of the angle of view of the display region, and
in a case where the minimum angle of view is included in the conditions information and the angle of view of the first stereo image is smaller than the minimum angle of view, set the angle of view of the display region to the minimum angle of view, and
in a case where the maximum angle of view is included in the conditions information and the angle of view of the first stereo image is larger than the maximum angle of view, set the angle of view of the display region to the maximum angle of view.

7. The image processing apparatus according to claim 6, wherein the conditions information includes at least one of a first distance that corresponds to the minimum angle of view and a second distance that corresponds to the maximum angle of view; and
in a case where the minimum angle of view and the first distance are included in the conditions information and the angle of view of the first stereo image is smaller than the minimum angle of view, set the distance from the display region to the observation viewpoint to the first distance, and
in a case where the maximum angle of view and the second distance are included in the conditions information and the angle of view of the first stereo image is larger than the maximum angle of view, set the distance from the display region to the observation viewpoint to the second distance.

8. The image processing apparatus according to claim 7, wherein the first distance is a distance that, in a case where an observer observing the second stereo image displayed on a display, allows the observer to fuse the second stereo image.

9. The image processing apparatus according to claim 7, wherein the second distance is a distance that, in a case where an observer observing the second stereo image displayed on a display, the observer most readily perceives a three-dimensional appearance.

10. The image processing apparatus according to claim 6, wherein the minimum angle of view is a central viewing angle in a case where an observer observes the second stereo image displayed on a display.

11. The image processing apparatus according to claim 6, wherein the maximum angle of view is defined as a maximum viewing angle of a display that displays the second stereo image.

12. The image processing apparatus according to claim 1 wherein at least one processor
acquire observer information including an interpupillary distance of an observer who observes the second stereo image on a display,
wherein
the parameters include information corresponding to a baseline length of the first stereo image, and
the at least one processor is configured to generate the second stereo image in which the angle of view of the display region is set based on the interpupillary distance, the baseline length, and the angle of view of the first stereo image.

13. The image processing apparatus according to claim 12, wherein the at least one processor is configured to generate the second stereo image in which the angle of view of the display region is set based on an angle of view obtained by scaling the angle of view of the first stereo image by a ratio between the baseline length and the interpupillary distance.

14. The image processing apparatus according to claim 1, further comprising:
a least one display, and
wherein the at least one processor displays the second stereo image on the display.

15. An image processing method, comprising:
acquiring a first stereo image having parallax for realizing stereoscopic vision, and parameters including information corresponding to an angle of view of the first stereo image; and
generating a second stereo image based on the first stereo image and the parameters,
wherein the second stereo image is generated such that an angle of view of a display region, for displaying all of the first stereo image from an observation viewpoint in a three-dimensional space reconstructed by the second stereo image, is set based on an angle of view of the first stereo image.

16. A non-transitory computer readable storage medium storing a program for causing a computer to perform an information processing method comprising:
acquiring a first stereo image having parallax for realizing stereoscopic vision, and parameters including information corresponding to an angle of view of the first stereo image; and
generating a second stereo image based on the first stereo image and the parameters,
wherein the second stereo image is generated such that an angle of view of a display region, for displaying all of the first stereo image from an observation viewpoint in a three-dimensional space reconstructed by the second stereo image, is set based on an angle of view of the first stereo image.
